(19) United States
(12) Patent Application Publication
(10) Pub. No.: US 2014/0094178 A1
(43) Pub. Date: Apr. 3, 2014

(54) PROACTIVE, LOCATION-BASED TRIGGER FOR HANDOVER AND REDIRECTION PROCEDURES

(71) Applicants: Suat R. Eskicioglu, Ottawa (CA); Csaba Marton, Ottawa (CA); Allan Ding, Ottawa (CA)

(72) Inventors: Suat R. Eskicioglu, Ottawa (CA); Csaba Marton, Ottawa (CA); Allan Ding, Ottawa (CA)

(21) Appl. No.: 13/633,287

(22) Filed: Oct. 2, 2012

(51) Int. Cl. H04W 36/32

(52) U.S. Cl. 455/440

(57) ABSTRACT

The exemplary embodiment uses geographical location information to trigger handover and redirection procedures. This process involves defining a network geographical grid and building an associated database of captured data from the user equipment, such as calculated KPI statistics per geographical location, and then using historical KPI statistics as the trigger for mobility and redirection decisions.

### BACKGROUND OF THE INVENTION

This invention relates to a method and apparatus that correlates geographical location information from user equipment with data relating to a network map to trigger handover and redirection procedures. While the invention is particularly directed to the art of wireless telecommunications, and will be thus described with specific reference thereto, it will be appreciated that the invention may have usefulness in other fields and applications.

By way of background, in the field of wireless telecommunications, such as cellular telephony, a system typically includes a plurality of base stations distributed within an area to be serviced by the system. Various users within the area, fixed or mobile, may then access the system and, thus, other interconnected telecommunications systems, via one or more of the base stations. Typically a user maintains communications with the system as the user passes through an area by communicating with one and then another base station, as the user moves. The user may communicate with the closest base station, the base station with the strongest signal, the base station with a capacity sufficient to accept communications, etc.

Quality of Experience (QoE) for the users in wireless networks is important to network operators because it is one of the elements that attracts, and helps keep, subscribers and also builds customer loyalty. To keep the Quality of Experience at its highest level, wireless network operators pay specific attention to optimizing the network resource usage, particularly the radio spectrum usage, which is a scarce and expensive resource.

To support the wide penetration of smartphones and the high throughput demands from their end users, many wireless network operators have deployed the Long Term Evolution (LTE) standard in addition to their existing Wideband Code Division Multiple Access (W-CDMA or WCDMA) and Global System for Mobile Communications (GSM) networks. In many parts of their networks, more than one carrier frequency has been deployed for W-CDMA and LTE networks to support high throughput, optimum Quality of Experience, and the always-on demands from an extensive number of subscribers. In other words, both capacity and Quality of Experience demands from subscribers forced the wireless network operators to deploy a number of W-CDMA and LTE carrier frequencies to meet these demands.

In such an environment, the challenge for the wireless network operators is to fully utilize the radio spectrum and network resources among different technologies and/or different carrier frequencies within each technology while maintaining the Quality of Experience for the end users, as defined, for example, by various network Key Performance Indicator (KPI) statistics.

Thus, it is helpful to know when and how to select the best cell and technology to make use of all available resources efficiently while also providing the subscribers an optimal Quality of Experience. Of course, this must be accomplished in a complex network deployment scenario where many carrier frequencies among different technologies have been deployed. As an example, a wireless operator may deploy in their network eight carrier frequencies among different technologies, e.g., two LTE, five W-CDMA and one GSM carrier frequencies. Each of the unique technology and carrier frequency pairs is defined as a layer. In this example, one can say that the network has eight layers.

Further, a function of a mobile radio network is mobility support, i.e., the ability to maintain a mobile radio connection of a mobile station even when the latter is moving out of the receiving range of one base station into the receiving range of another base station. For this purpose a so-called handover may be initiated, i.e., the connection of a mobile station to a base station A is handed over to a base station B at a defined point of time.

A number of reactive triggers to initiate cell and/or carrier frequency redirection or handover procedures are deployed in wireless networks. Prominent reactive triggers include radio conditions and resource shortage or congestion. When radio conditions deteriorate to a level that is worse than a given threshold (either an absolute value threshold or a comparative threshold between the radio conditions of two candidate cells or carrier frequencies), then in the network a decision is made to select another cell or carrier frequency to redirect the session or hand over the session to. A similar logic is applied when the shortage of radio, or other resources are used as the trigger for mobility.

Even though good network KPI numbers could be achieved with these reactive triggers, there is still room for improvement, which can be achieved, for example, with proactive triggers. With triggers based on radio condition degradation and network congestion, the network is simply reacting to the conditions that have already occurred. In some cases, it may be too late to make the right decision to save the session when, for example, radio conditions have already degraded to such a level that is not even possible to redirect or handover a session to a better cell or carrier frequency.

Thus, there is a need for a method of triggering a handover or redirection to the most suitable cell in a complex network deployment in a proactive manner. Historical KPI statistics on a per grid-zone basis can be used as a proactive trigger for handover and redirection decisions. This type of trigger for handover and redirection procedures utilizes relevant data available in a more granular form than on a per cell basis, especially the data that changes depending on the location of the user in the cell.

### SUMMARY OF THE INVENTION

The exemplary embodiment uses the information at the geographical location of the user equipment to assist in the triggering of handover and redirection procedures. This process involves building a geographical grid that is logically overlaid on a cellular network and an associated database to capture radio measurements and calculate KPI statistics per geographical location, i.e. per grid-zone, and then using this data to trigger mobility decisions.

In one embodiment, a method of providing a trigger for handover or redirection of a call session in a communications network is provided. The method includes creating a geographical grid covering two or more layers in a cellular network, wherein a layer is defined as a unique combination comprising a cellular technology paired with a carrier frequency and the geographical grid is divided into a plurality of grid-zones. Data is collected for each of the layers within the cellular network grid from a plurality of user equipments and stored in a network map database. The data collected is used at least to calculate network key performance indicator (KPI) statistics on a per grid-zone basis per technology and carrier frequency. Once the geographical grid has been created and data stored, geographical location information from a particular user equipment is obtained. The geographical location information for the particular user equipment is mapped to a particular grid-zone in the geographical grid. A handover or redirection of the call session is triggered, based on the historical key performance indicator (KPI) records or statistics stored in the database for the particular grid-zone. The handover or redirection may be made to a target cell of a different cellular technology and/or a different carrier frequency.

In another embodiment, a method of providing a trigger for handover or redirection of a call session in a communications network is provided. The method includes creating a geographical grid covering two or more layers in a cellular network, wherein a layer is defined as a unique combination comprising a cellular technology paired with a carrier frequency and the geographical grid is divided into a plurality of grid-zones. Data is collected for each of the layers within the cellular network grid from a plurality of user equipments and stored in a network map database. The data collected is used at least to calculate network key performance indicator (KPI) statistics on a per grid-zone basis per technology and carrier frequency. While a particular user equipment is in a connected state, geographical location information from the particular user equipment is obtained. The geographic location information for the particular user equipment is mapped to a particular grid-zone in the geographical grid. The historical KPI statistics stored in the database for the particular grid-zone are used to trigger a handover of a session to another cellular technology or to another carrier frequency.

In yet another embodiment a method of providing a trigger for mobility decisions in a communications network is provided. The method includes creating a geographical grid covering two or more layers in a cellular network, wherein a layer is defined as a unique combination comprising a cellular technology paired with a carrier frequency and the geographical grid is divided into a plurality of grid-zones. Data is collected for each of the layers within the cellular network grid from a plurality of user equipments and stored in a network map database. The data collected is used at least to calculate network key performance indicator (KPI) statistics on a per grid-zone basis per technology and carrier frequency. When a particular user equipment is going into a connected state, the geographical location information from the particular user equipment reported in a Connection Request message is mapped to a particular grid-zone in the geographical grid. The historical KPI statistics stored in the database for the particular grid-zone are used to trigger a redirection of a call session for the particular user equipment to a target cell.

In yet another embodiment, a system for providing a trigger for handover or redirection of a call session in a communications network is provided. The system includes at least a network map database and one or more processors. The one or more processors may be operative to create a geographical grid covering two or more layers in a cellular network, wherein a layer is defined as a unique combination comprising a cellular technology paired with a carrier frequency and the geographical grid is divided into a plurality of grid-zones, and collect data for each of the layers within the cellular network grid from a plurality of user equipments and storing the data in a network map database, wherein the data collected is used at least to calculate network key performance indicator (KPI) statistics on a per grid-zone basis per technology and carrier frequency. The one or more processors may be further operative to obtain geographical location information from a particular user equipment, wherein the particular user equipment is involved in a call session with a given cellular technology and a given carrier frequency, map the geographical location information for the particular user equipment to a particular grid-zone in the geographical grid, and trigger a handover or redirection of the call session to a target cell based on the historical KPI statistics stored in the database for the particular grid-zone.

Optionally, with regard to any of the preceding embodiments, the cellular network technologies may comprise Wideband Code Division Multiple Access and/or 4G Long Term Evolution. In addition, any of the preceding embodiments may further include adding an additional location parameter in one or more signaling messages to carry the location information when a call session has dropped or failed to establish and calculating the establishment success rate (ESR) and session drop rate (SDR) statistics on a per grid-zone basis using the location information in at least one of the following types of messages: Radio Resource Control (RRC) Connection Request, RRC Connection Setup Complete, RRC Connection Release Complete, RRC Cell Update, RRC Radio Bearer Release Complete. Further, the geographical grid described above may cover substantially all the layers in the cellular network.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an exemplary communications system suitable for implementing aspects of the present invention;

FIG. 2 is a flow chart of an exemplary method of using the geographical location of user equipment to trigger a handover or redirection of a call session in accordance with aspects of the present invention; and

FIG. 3 shows a perspective view of a cellular network featuring layers of different cellular technologies and carrier frequencies along with the grid and the grid-zones with the associated database and its entries in accordance with aspects of the present invention.

### DETAILED DESCRIPTION

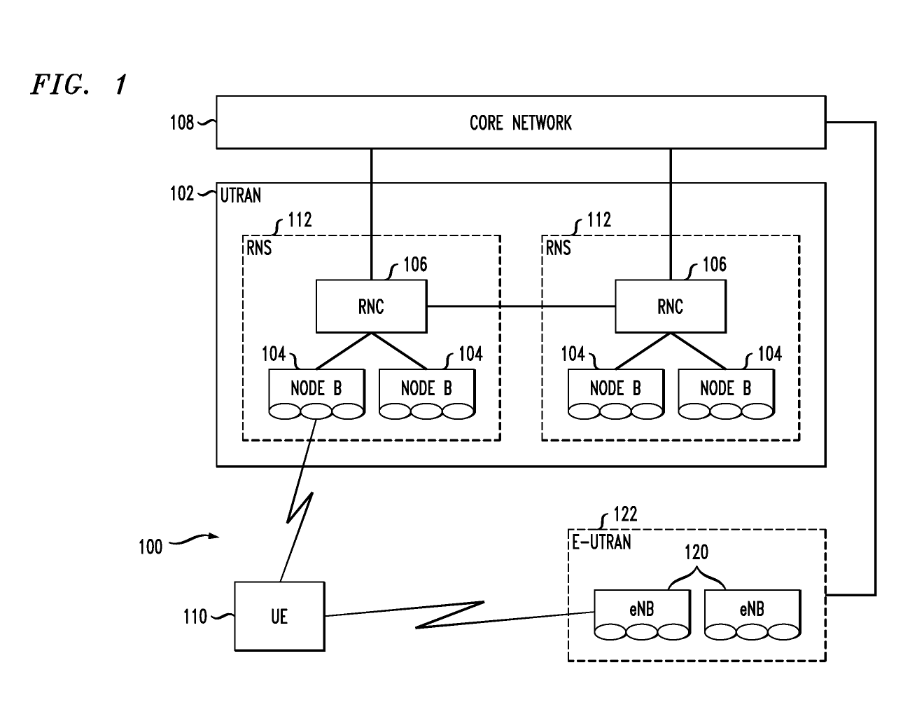

Referring now to the drawings wherein the showings are for purposes of illustrating the exemplary embodiments only and not for purposes of limiting the claimed subject matter, FIG. 1 shows an exemplary communication system 100 in accordance with aspects of the present invention.

As described herein, the communication system 100 generally includes a radio access network 102 such as the Universal Terrestrial Radio Access Network (UTRAN). UTRAN is a collective term for the Node Bs 104 and Radio Network Controllers (RNCs) 106 that make up the Universal Mobile Telecommunications System (UMTS) radio access network. UMTS is an umbrella term for the third generation (3G) radio technologies developed within 3GPP. The radio access specifications provide for Frequency Division Duplex (FDD) and Time Division Duplex (TDD) variants, and several chip rates are provided for in the TDD option, allowing UTRA technology to operate in a wide range of bands and co-exist with other radio access technologies. UMTS includes the original W-CDMA scheme.

The radio access network 102 connects to the core network 108, which is an evolution from the GSM core. This communications network can carry many traffic types from real-time circuit-switched to IP-based packet-switched. The UTRAN 102 allows connectivity between the user equipment (UE) 110 and the core network (CN) 108.

More particularly, the UTRAN 102 includes a number of base stations, which are generally called Node Bs 104, and Radio Network Controllers (RNC) 106. The RNC 106 provides control functionalities for one or more Node Bs 104. The RNC 106 and its corresponding Node Bs 104 make up the Radio Network Subsystem (RNS) 112. There can be more than one RNS present in a UTRAN.

The RNS 112 can be either a full UTRAN or only a part of a UTRAN An RNS offers the allocation and release of specific radio resources to establish means of connection in between the UE 110 and the UTRAN 102. A Radio Network Subsystem 112 generally contains one RNC and is responsible for the resources and transmission and reception in a set of cells.

The user equipment (UE) 110 may take the form of any of a variety of mobile devices, including cellular phones, smartphones, personal digital assistants (PDAs), laptop computers, tablet computers, digital pagers, wireless cards, and any other device capable of accessing a data network through the base station 104.

Generally, the RNC 106 operates to control and coordinate the base stations 104 to which it is connected. The RNC 106 of FIG. 1 generally provides replication, communications, runtime, and system management services. The RNC 106, in the illustrated embodiment handles call processing functions, such as setting and terminating a call path and is capable of determining a data transmission rate on the forward and/or reverse link for each UE 110 and for each sector supported by each of the base stations 104.

The UE 110 communicates with multiple Node Bs 104. The Node B 104 is a base station responsible for physical layer processing such as forward error correcting coding, modulation, spreading, and conversion from baseband to RF signal transmitted from antenna. The Node B 104 can handle transmission and reception from one to several cells. One RNC may controls multiple (up to thousands) Node Bs.

FIG. 1 also shows that the UE 110 may be connected to an E-UTRAN (Evolved UTRAN) 120 instead of the UTRAN 102. 3GPP also developed Long Term Evolution (LTE), which evolves from UMTS and GSM. It is also noted that the E-UTRAN Node B 122, also known as Evolved Node B and abbreviated as eNode B or eNB, is the element in E-UTRAN 120 of LTE that is the evolution of the element Node B in UTRAN of UMTS. Traditionally, a NodeB has minimum functionality (except HSPA), and is controlled by an RNC. However, with an eNodeB, there is no separate controller element. This simplifies the network architecture and allows faster response times.

Generally the CN 108 operates as an interface to a data network (not shown) and/or to a publicly switched telephone network (PSTN) (not shown). The CN 108 performs a variety of functions and operations, such as user authentication, however, a detailed description of the structure and operation of the CN 108 is not necessary to an understanding and appreciation of the instant invention. As such, further details of the CN 108 are not presented herein.

Thus, those skilled in the art will appreciate that the communications system 100 facilitates communications between the UE 110 and the data network and the PSTN. It should be understood, however, that the configuration of the communications system 100 of FIG. 1 is exemplary in nature and that fewer or additional components may be employed in other embodiments of the communications system 100 without departing from the spirit and scope of the instant invention.

Cellular sites are what the user equipment “talk” to. They include one or more transmit and receive antennas. Each antenna covers a particular geographical area. A wireless service provider may only have one cell site in a small community, whereas they may have hundreds or even thousands of cell sites in a large urban center.

A mobile network operator (also known as a wireless service provider, wireless carrier, cellular company, or mobile network carrier) is a provider of wireless communications services that owns or controls the elements necessary to sell and deliver services to an end user including radio spectrum allocation, wireless network infrastructure, back haul infrastructure, billing, customer care and provisioning computer systems and marketing, customer care, provisioning and repair organization.

Cells may provide coverage in a radius around a tower or base station (or in a sectorized deployment, which is more common). Users of cell phones within that radius are able to access wireless services. The distance that the radius covers is determined by the power output of the cell site, the amount of background noise, and other environmental interferences, among other things. In a real environment, cells do not provide radial coverage due to geographical features and interference from buildings. Places that have a relatively flat terrain and equipped with omni-directional antenna will have cells that radiate near-perfect circles of coverage. Cell towers in locations with rough terrain or large man-made objects (e.g., buildings) may have distorted cell coverage.

The exemplary embodiment utilizes geographical location information associated with the user equipment 100 to trigger a handover or redirection of a call session to a target cell. This process involves, for example, defining a network grid to aid in building a database of captured data from the user equipment 100, using that data to calculate KPI statistics per geographical location, and then using the historical KPI statistics for triggering mobility decisions.

Unless specifically stated otherwise, or as is otherwise apparent from the discussion, terms such as “processing” or “computing” or “calculating” or “determining” or “displaying” or “predicting” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

The term “location” as used herein refers to the geographical location of the user equipment, which can also be referred to as geolocation. Geolocation may be described with a geographic coordinate system, using the ellipsoid point Latitude and Longitude (see 3GPP Specification 23.032). This new network functionality uses geolocation information to trigger a handover or redirection of a call session to a target cell and technology, for example, (a) during a connected state or (b) while going into a connected state or performing service establishment.

The exemplary mobility trigger, which that depends on the location of the user equipment within the cell coverage area, is based on historical KPI statistics. Historical KPI statistics may include, for example, one or more of the establishment success rate (ESR), the session drop rate (SDR), and the call drop rate (CDR). Of course, it is to be understood that other types of KPI statistics may be used as well.

Use of the geographic location of the user equipment 110 provides a more granular view than only using the cell information, thus enabling a more accurate KPI statistics value to be used as handover or relocation trigger.

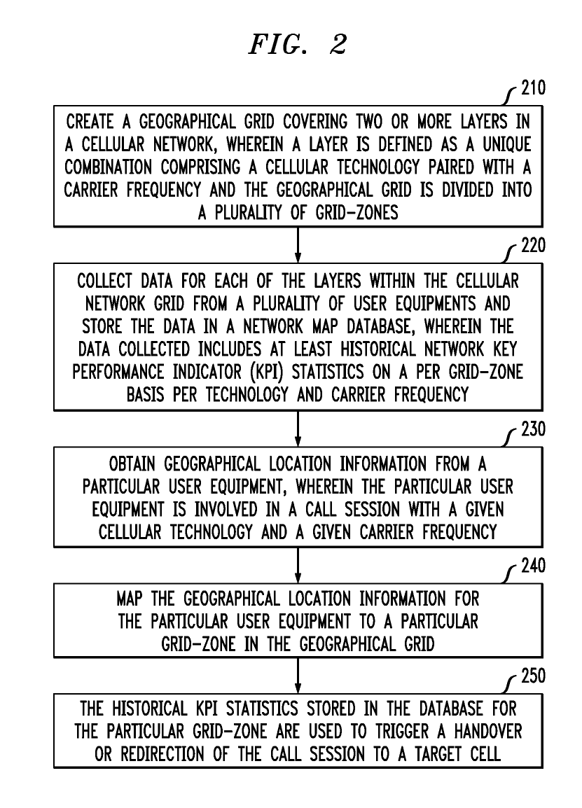

With reference to FIG. 2, the exemplary method includes creating a geographical grid covering the layers in a cellular network (210). It is noted that a cellular network may include multiple technologies, with each technology including multiple carrier frequencies. For example, a given cellular network may incorporate LTE and W-CDMA technologies, each having multiple carrier frequencies. Each of the unique technology and carrier frequency pairs is also called a layer.

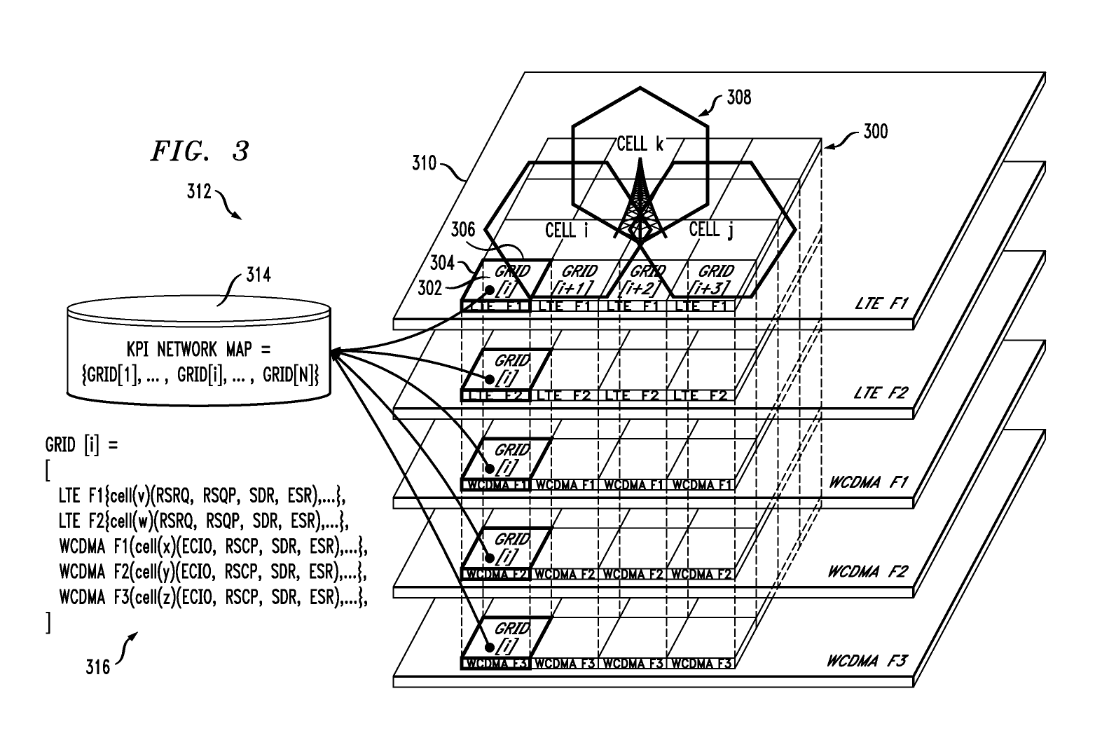

An exemplary network grid 300 is shown in FIG. 3. The grid 300 includes a number of grid-zones 302 (e.g., grid-zone i, grid-zone i+1, grid-zone i+2, grid-zone i+3, and so on) formed by the intersection of vertical gridlines 304 and horizontal gridlines 306 over a cellular network map 308 (e.g., cell i, cell j, cell k, and so on). By way of example, the grid-zone 302 could be a square having a size that is approximately 0.001373 degrees. It is to be understood, however, that other sizes and shapes, such as rectangles, could be utilized. For example, the index of the grid-zone 302 may be the southeast corner of the grid-zone (in the Northern Hemisphere), and it may be calculated as follows:
Latitude: reported degreesLatitude Mod 128
Longitude: reported degreesLongitude Mod 64

The process may be repeated for each layer 310 (e.g., LTE F1, LTE F2, W-CDMA F1, W-CDMA F2, W-CDMA F3, and so on) in the cellular network 312.

Next, data for each of the layers 310 and/or grid-zones (or locations) 312 within the cellular network 310 is collected, and calculated if necessary, and then stored in a network map database 314 (220). An exemplary matrix 316 for a given grid-zone [i] is shown in FIG. 3.

Such collected and calculated data may include, but is not limited to, radio measurements and historical KPI statistics. Radio measurements may include, for example, one or more of the energy per chip divided by the total in-band interference (or the Ec/No) of the common pilot channel (or CPICH), the received signal code power (RSCP) of the CPICH reference signal for the W-CDMA network, and the received power (RSRP), and the reference signal receive quality (RSRQ) for the LTE network. Of course, it is to be understood that other types of radio measurements may be used as well. The historical KPI statistics were mentioned earlier, such as ESR, SDR, and CDR.

A Radio Resource Control (RRC) protocol belongs to the 3GPP protocol stack and handles the control plane signaling of Layer 3 between the UEs (User Equipment) 110 and the UTRAN 102 or the E-UTRAN 120. An additional location parameter may be included in the following RRC messages to receive the location information when the session has dropped or failed to establish, and subsequently to calculate the ESR, SDR, and CDR statistics on a per grid-zone basis using the location information in the messages:
RRC Connection Request
RRC Connection Setup Complete
RRC Connection Release Complete
RRC Cell Update
RRC Radio Bearer Release Complete

The grid 300 of every layer 310 is built using the measurements received from the UE 110 on that layer. The data may be collected from a plurality of UEs 110 in real time or for one or more specified time periods.

Finally, the exemplary embodiment includes triggering handover or redirection procedures for the user equipment based on the geographical location of the user equipment 110 and the collected data for the grid. In this regard, geographical location information for a particular user equipment is obtained (230). The geographical location information for the particular user equipment is mapped to a particular grid-zone in the geographical grid (240). A handover or redirection of the call session is triggered based on the data (e.g., historical KPI statistics) stored in the database for the particular grid-zone, as opposed to using radio conditions and resource availability as triggers for mobility decisions. Handover or redirection may be made to a target cell of a different cellular technology and/or a different carrier frequency (250).

Thus, geolocation information is used to proactively trigger a handover or redirection of a call session to a target cell with a particular technology and carrier frequency. This process includes at least two scenarios. In one scenario, while in the connected state, the geographical location of the user equipment is reported to the RNC 106 (or to the eNobe B 120) in the RRC Measurement Report message or any other RRC message that the user equipment happens to send during the session. The geographical location information reported in the message is mapped to a particular grid-zone 302 in the grid 300, and the KPI statistics for that grid-zone 302 are used to trigger a handover procedure towards a target cell. This trigger materializes when the KPI statistics of the grid-zone is worse than a pre-set KPI statistics threshold that can be configured by the operator.

Thus, the proactive approach of the exemplary embodiment improves Quality of Experience by triggering a handover based on the network KPI statistics per geographical grid-zone without necessarily considering the radio conditions or other criteria.

In another scenario, while going into a connected state, which may include performing service establishment, as a result of an RRC Connection Request message, the geographical location of the user equipment is reported, for example, to the RNC 106 (or to the eNobe B 120). The geographical location information reported in the message is mapped to a particular grid-zone 302 in the grid 300, and KPI statistics for that grid-zone 302 are used to trigger a redirection procedure towards a target cell. This trigger materializes when the KPI statistics of the grid-zone is worse than a pre-set KPI statistics threshold that can be configured by the operator. Thus, the proactive approach of the exemplary embodiment improves Quality of Experience by triggering a redirection based on the network KPI statistics per geographical grid-zone without necessarily considering the radio conditions or other criteria.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” controller should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein the instructions perform some or all of the steps of the above-described methods. The program storage devices may be, e.g., digital memories, magnetic storage media such as a magnetic disks and magnetic tapes, hard drives, or optically readable digital data storage media. The embodiments are also intended to cover computers programmed to perform the steps of the above-described methods.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method of providing a trigger for handover or redirection of a call session in a communications network, the method comprising:
creating a representation of a geographical grid covering two or more layers in a cellular network, wherein a layer is defined as a unique combination comprising a cellular technology paired with a carrier frequency and the geographical grid is divided into a plurality of grid-zones;
collecting data for the layers within the representation of the geographical grid from a plurality of user equipments and storing the data in a network map database, wherein the data is used for calculating one or more network key performance indicator (KPI) statistics on a per grid-zone basis per technology and carrier frequency;
obtaining geographical location information from a particular user equipment, wherein the particular user equipment is involved in a call session with a given cellular technology and a given carrier frequency;
mapping the geographical location information for the particular user equipment to a particular grid-zone in the representation of the geographical grid; and
using at least one of the one or more network KPI statistics the database for the particular grid-zone to trigger a handover or redirection of the call session to a target cell.

2. The method of claim 1, wherein the cellular network technology comprises at least Wideband Code Division Multiple Access and 4G Long Term Evolution.

3. The method of claim 1, wherein the handover or redirection is made to a target cell of a different cellular technology and/or a different carrier frequency.

4. The method of claim 1,
wherein the obtaining geographical location information comprises receiving the geographical location information in an additional location parameter of one or more signaling messages when a call session has dropped or failed to establish;
the method further comprising calculating the establishment success rate (ESR) and session drop rate (SDR) statistics on a per grid-zone basis using the location information in at least one of the following types of messages: Radio Resource Control (RRC) Connection Request, RRC Connection Setup Complete, RRC Connection Release Complete, RRC Cell Update, RRC Radio Bearer Release Complete.

5. (canceled)

6. The method of claim 1, further comprising:
redirecting or handing over the call session to a target cell of a particular cellular technology.

7. The method of claim 1, further comprising:
redirecting or handing over the call session to a target cell of a particular carrier frequency.

8. The method of claim 1, further comprising:
while a particular user equipment is in a connected state, obtaining geographical location information from the particular user equipment in a measurement report;
mapping the geographic location information obtained for the particular user equipment to a particular grid-zone in the representation of the geographical grid; and
using at least one of the one or more KPI statistics for the particular grid-zone to trigger a handover of a session to another cellular technology or to another carrier frequency.

9. The method of claim 8, wherein the cellular network technology comprises at least Wideband Code Division Multiple Access (W-CDMA) and 4G Long Term Evolution (LTE).

10. (canceled)

11. The method of claim 1,
further includes radio measurements on a per grid-zone basis per technology and carrier frequency;
the method further comprising when a particular user equipment is going into a connected state or when performing service establishment with a particular user equipment, mapping the geographical location information for the particular user equipment reported in a Connection Request message to a particular grid-zone in the representation of the geographical grid; and
using at least one of the one or more KPI statistics for the particular grid-zone to trigger a redirection of a call session for the particular user equipment to a target cell.

12. The method of claim 11, wherein the cellular network technology comprises at least Wideband Code Division Multiple Access (W-CDMA) and 4G Long Term Evolution (LTE).

13. (canceled)

14. A system for providing a trigger for handover or redirection of a call session in a communications network, the system comprising:
a network map database;
one or more processors configured to:
create a representation of a geographical grid covering two or more layers in a cellular network, wherein a layer is defined as a unique combination comprising a cellular technology paired with a carrier frequency and the geographical grid is divided into a plurality of grid-zones;
collect data for the layers within the representation of the geographical grid from a plurality of user equipments and store the data in a network map database, wherein the data includes at least historical network key performance indicator (KPI) statistics on a per grid-zone basis per technology and carrier frequency;
obtain geographical location information from a particular user equipment, wherein the particular user equipment is involved in a call session with a given cellular technology and a given carrier frequency;
map the geographical location information for the particular user equipment to a particular grid-zone in the representation of the geographical grid; and
use at least one of the one or more KPI statistics stored in the database for the particular grid-zone to trigger a handover or redirection of the call session to a target cell.

15. The system of claim 14, wherein the cellular network technology comprises at least Wideband Code Division Multiple Access and 4G Long Term Evolution.

16. The system of claim 14, wherein the handover or redirection is made to a target cell of a different cellular technology and/or a different carrier frequency.

17. The system of claim 14, wherein the one or more processors are further configured to:
receive the geographical location information in an additional location parameter of one or more signaling messages when a call session has dropped or failed to establish;
calculate establishment success rate (ESR) and session drop rate (SDR) statistics on a per grid-zone basis using the location information in at least one of the following types of messages: Radio Resource Control (RRC) Connection Request, RRC Connection Setup Complete, RRC Connection Release Complete, RRC Cell Update, RRC Radio Bearer Release Complete.

18. (canceled)

19. The system of claim 14, wherein the one or more processors are further configured to:
redirect or hand over the call session to a target cell of a particular cellular technology.

20. The system of claim 14, wherein the one or more processors are further configured to:
redirect or hand over the call session to a target cell of a particular carrier frequency.
